(19) United States
(12) Patent Application Publication
(10) Pub. No.: US 2020/0066460 A1
(43) Pub. Date: Feb. 27, 2020

(54) SUPERCAPACITOR DEVICE

(71) Applicant: ZapGo Ltd., Harwell (GB)

(72) Inventors: Stephen David VOLLER, Harwell (GB); David MCTURK, Harwell (GB)

(73) Assignee: ZapGo Ltd., Harwell (GB)

(21) Appl. No.: 16/609,753

(22) PCT Filed: May 2, 2018
(86) PCT No.: PCT/GB2018/051175

§ 371 Date: Oct. 31, 2019

(30) Foreign Application Priority Data
May 2, 2017 (GB) 1706975.8

(51) Int. Cl. H01G 11/08; H01G 11/36; H02J 7/00

(52) U.S. Cl. CPC H01G 11/08; H02J 7/0054; H01G 11/36

(57) ABSTRACT

An electrical device is provided. It is characterised by comprising:
at least one operative element for performing the assigned duty of the device;
a supercapacitor comprised of nano-carbon containing electrodes, an ionic liquid electrolyte and an ion-permeable membrane for powering the operative element and/or recharging an associated battery;
a charging circuit for recharging the supercapacitor by means of an external source of power;
a control circuit for controlling operation of the operative element;
a monitoring circuit for monitoring one or more parameters characteristic of the performance of the supercapacitor and/or the operative element and for generating corresponding status information;
a transmitter for transmitting a first signal comprising the status information to a remote receiving location and
a receiver for receiving a second signal from the remote receiving location comprising instructions to be acted on by the control unit and optionally the operative element.

This invention relates to an electrical device containing a supercapacitor which is adapted to transmit a data stream to a remote location and receive instructions from the remote location based on an analysis of the data.

US20120274273 at paragraphs 299-209 describes an integrated-circuit battery device which integrates energy, communication and electronics in a single platform device such as a pacemaker.

WO2014066824 generally describes a supercapacitor and an arrangement for miniature implantable medical devices.

US20130106341 teaches a hybrid battery system for portable electronic devices.

In previous applications, such as WO2016075431, we have disclosed rechargeable battery chargers and novel supercapacitor cells based on nano-carbon containing electrodes and ionic liquid electrolytes which are superior in performance to conventional lithium-ion batteries in a range of energy-storage applications. In particular, these cells exhibit much longer useful cycle lives; for example reaching 100,000 or even 1,000,000 charge/discharge cycles without a noticeable diminution in their charge-holding capacity or an increase in electrical resistance. This means than in many instances their utility can exceed the operative elements they are designed to power.

As a consequence, they are extremely attractive for device applications where the routine replacement of parts is undesirable (e.g. where the device is designed to be waterproof) or where access to the environment in which the device is deployed can be difficult, disruptive or hazardous. For example, in emergency lighting or environmental-monitoring systems, the cell can be permanently built into the fabric of the building.

If this approach is adopted, it is highly desirable, for technical reasons, for the device to further include a control system which is linked remotely to the outside world by means of a transmitter/receiver so the performance of the device and the cell itself can be closely monitored and adjusted if an emergency arises or the operating requirements change. Such adjustment(s) could be in the form of a switching on or off of the device in certain circumstances (different weather, different seasons, during general building maintenance etc.), a modification of the periodicity of charging and discharging of the supercapacitor or a modification in advance of a warning of the imminent breakdown of the device. It can also allow the energy consumption of the device to be controlled remotely which can be extremely desirable in circumstances where energy is currently provided on a metered or pay-as-you-go basis.

We have now applied this approach to our supercapacitor cells to generate devices which not only exhibit a high-degree of remote controllability but also can be used in in situations where replacement of the power-source is undesirable. Thus, according to the present invention there is provided an electrical device characterised by comprising:
at least one operative element for performing the assigned duty of the device;
a supercapacitor comprised of nano-carbon containing electrodes, an ionic liquid electrolyte and an ion-permeable membrane for powering the operative element and/or recharging an associated battery;
a charging circuit for recharging the supercapacitor by means of an external source of power;
a control circuit for controlling operation of the operative element;
a monitoring circuit for monitoring one or more parameters characteristic of the performance of the supercapacitor and/or the operative element and for generating corresponding status information;
a transmitter for transmitting a first signal comprising the status information to a remote receiving location and
a receiver for receiving a second signal from the remote receiving location comprising instructions to be acted on by the control unit and optionally the operative element.

The other constituent parts of the device can be used to provide power to a wide range of operative elements. For example, in one embodiment the operative element is a light bulb or lighting unit especially one which needs to be able to function in the event of a mains power failure or disruption. In another, it is an environmental-monitoring device such as a smoke, carbon monoxide or other gas detector. In yet another, it is a sensor node often referred to in the industry as a ‘mote’ in which the sensor senses a critical physical parameter such as temperature, pressure, vibration, force, thickness or the like for reporting purposes. Often, such motes are deployed on industrial plant (factories, mines, oil refineries and chemical plant and storage units) in multiple locations and are connected to one another and/or a central data-receiving location by means of a wireless or permanently cabled network. In yet another embodiment, the operative element is one which provides electrical energy to a retail consumer or a wholesale or industrial customer and is enclosed in a casing which is designed to be tamper-proof or is armoured or otherwise resistant to traumatic events.

In one embodiment of the invention, the nano-carbon containing electrodes of the supercapacitor comprise anode and cathode surfaces consisting essentially of an electrically-conductive metal current collector in the form of a thin flexible sheet (for example aluminium, silver or copper foil) coated with a layer comprised of carbon charge-carrying elements including nano-carbon components. In another embodiment, at least some of these anode and cathode surfaces are disposed on opposite sides of the same sheet. Suitably, at least some of these charge-carrying elements are particles of carbon having an average longest dimension of less than 10 microns. Preferably, these particles exhibit mesoporosity with the mesopores being in the size range 2 to 50 nanometres. In another embodiment, the carbon charge-carrying elements may be supplemented by nanoparticles of materials which can confer a degree of pseudocapacitance behaviour on the final supercapacitor; for example, salts, hydroxides and oxides of metals such as lithium or transition metals with more than one oxidation state including nickel, manganese, ruthenium, bismuth, tungsten or molybdenum.

In one embodiment, the layer is comprised of carbon particles embedded in a polymer binder matrix and is characterised by the weight ratio of the particles to the binder being in the range 0.2:1 to 20:1. In another, the binder is electrically conductive. In yet another embodiment, the carbon particles include graphene particles; in yet another they include carbon nanotubes. In one preferred embodiment a mixture of graphene and carbon nanotubes are employed optionally with activated carbon being present. In yet another suitable embodiment, the carbon particles comprise a mixture of these three components with the activated carbon, carbon nanotubes and graphene being present in the weight ratio 0.5-2000:0.5-100:1; preferably 0.5-1500:0.5-80:1.

By the term activated carbon is meant any amorphous carbon of high purity whose surface area is typically greater than 500 m²g⁻¹ preferably from 1500 to 2500 m²g⁻¹ and which has an average particle size of less than 1 micron. Such materials are readily available from a number of commercial sources. The carbon nanotubes used typically have an average length in the range 2-500 microns (preferably 100-300 microns) and an average diameter in the range 100-150 nanometres. The nanotubes may be single- or multi-walled or a mixture of both.

By the term graphene is meant the allotrope of carbon whose particles are substantially two-dimensional in structure. In extremis, these particles comprise single atomic-layer platelets having a graphitic structure although for the purposes of this invention this component may comprise a small number of such platelets stacked one on top of another e.g. 1 to 20 preferably 1 to 10 platelets. In one embodiment, these platelets are in a non-oxidised form. In another, the platelets independently have average dimensions in the range 1 to 4000 nanometres preferably 20 to 3000 or 10 to 2000 nanometres as measured by transmission electron microscopy. Any known method can be used to manufacture such materials which are also available commercially; for example, under the name Elicarb® by Thomas Swann Limited in the United Kingdom.

In another embodiment, the carbon charge-carrying elements may further include up to 20%, preferably 1 to 20% by weight of a conducting carbon. Suitably, this conducting carbon comprises a highly conductive non-graphitic carbon having a polycrystalline structure and a surface area in the range 1 to 500 m²g⁻¹. In one embodiment, it is a carbon black; for example, one of those material which have been used as conducting additive in lithium-ion batteries (for example Timcal SuperC65® and/or Timcal SuperC45).

In one embodiment, the residual moisture in the electrodes after manufacturing should be less than 100 ppm; preferably less than 50 ppm.

In yet another embodiment, the carbon-containing anode(s) and cathode(s) are asymmetric to one another; in other words, they have differing thicknesses—for example layers of differing thicknesses or have additives having a pseudocapacitance effect added.

Turning to the conductive binder, this is suitably comprised of one or more electrically conductive polymers and is preferably selected from a cellulose derivative, a polymeric elastomer or mixtures thereof. In one embodiment, the cellulose derivative is a carboxyalkyl cellulose for example carboxymethyl cellulose. In another embodiment, the elastomer is a styrene-butadiene rubber or a material having equivalent properties.

Suitably, the total charge-bearing surface area of the various components in the composite layer is >250 m²g⁻¹ preferably >260 m²g⁻¹.

In another embodiment, the electrode is a self-supporting and does not employ a metal current collector and is characterised by comprising a rigid or mechanically resilient, electrically-conductive sheet consisting essentially of a nano-carbon containing matrix of from 75-90% by weight of the activated carbon and 5 to 25% by weight of the conductive carbon uniformly dispersed in from 5 to 15% by weight of a polymer binder. Suitable examples of such sheets will have a density of greater than 0.4 grams per cm³, an average gravimetric capacitance in excess of 100 Farads per gram and an equivalent series resistance (ESR) of less than 30 ohms when measured in coin cells.

Turning to the ionic liquid electrolyte, this suitably comprises an organic ionic salt which is molten below 100° C. and is preferably so at or below ambient temperatures. In another embodiment, it is a mixture comprised of one or more ionic liquids and the mixture has a viscosity at 25° C. in the range 10 to 80 centipoise; preferably 20 to 50 centipoise. In yet another embodiment, the electrolyte is a eutectic or near-eutectic mixture of at least two components one of which is an ionic liquid. Suitably, these mixtures have a melting point below 100° C. preferably below 50° C.; and more preferably below 30° C. Eutectic behaviour is a well-known characteristic of those mixtures of two or more components whose melting point is significantly depressed over a given composition range relative to what might be expected on the basis of Raoult's law. Here, the term ‘eutectic or near-eutectic mixture’ is therefore to be construed as encompassing any mixture of components according to the invention whose melting point shows such a depression; with those having a depression greater than 50%, preferably greater than 90% of the depression at the actual eutectic point being most preferred. In an especially preferred embodiment, the eutectic composition itself is employed as the electrolyte. In another embodiment, at least one of the ionic liquids employed has an electrochemical window greater than 3 v.

In one embodiment, the electrolyte employed is a mixture, e.g. a eutectic or near-eutectic mixture, comprised of at least one of the ionic liquids described in U.S. Pat. No. 5,827,602 or WO2011/100232, to which the reader is directed for a complete listing. In another embodiment, the mixture consists of at least two of the said ionic liquids.

Suitably, the ionic liquid employed or one of the ionic liquids employed in the electrolyte is thus a quaternary salt of an alkyl or substituted-alkyl pyridinium, pyridazinium, pyrimidinium, pyrazinium, imidazolium, piperidinium, pyrrolidinium, pyrazolium, thiazolium, oxazolium, triazolium or azepanium cation. In such a case, it is preferred that the counter-anion associated with each cation is large, polyatomic and has a Van der Waals volume in excess of 50 or 100 angstroms (see for example U.S. Pat. No. 5,827,602 which provides illustrative examples contemplated as being within the scope of our invention). It is also preferred that the anion is chosen so that it is asymmetric with respect to the cation ensuring that the ions in the liquid do not easily close pack and cause crystallisation. In one embodiment, the counter-anion is selected from the group consisting of tetrafluoroborate, hexafluorophosphate, dicyanamide, bis(fluorosulphonyl)imide (FSI), bis(trifluoromethylsulphonyl)imide (TFSI) or bis(perfluoroC₂ to C₄alkylsulphonyl)imide e.g. bis(perfluoroethylsulphonyl)imide anions or analogues thereof. In another preferred embodiment the ionic liquid(s) are selected from C₁ to C₄ alkyl substituted imidazolium, piperidinium or pyrrolidinium salts of these anions with any permutation of cations and anions being envisaged as being disclosed herein. From amongst this list the following binary systems are preferred: a piperidinium salt and an imidazolium salt; a piperidinium salt and a pyrrolidinium salt and an imidazolium salt and a pyrrolidinium salt. In alternative embodiments, the binary system may comprise either (a) a piperidinium salt and any substituted bulky quaternary ammonium salt of one of the above-mentioned anions; e.g. a tralkyl(alkoxylalkyl)ammonium salt thereof where the alkyl or alkoxy moieties independently have one, two, three or four carbon atoms or (b) one or more of the azepanium salts exemplified WO2011/100232. In all of the cases referred to above, the salts employed should preferably each have an electrochemical window of greater than 3 volts and a melting point below 30° C.

Specific, non-limiting examples of electrolytes which can be employed include salts or mixtures of salts derived from the following cations; 1-ethyl-3-methylimidazolium (EMIM), 1-butyl-3-methylimidazolium (BMIM), 1-methyl-1-propylpyrrolidinium, 1-methyl-1-butylpyrrolidinium and the anions mentioned above. In one embodiment the electrolyte is one or more tetrafluoroborate, FSI or TFSI salts of these cations. In another it is the same salt used in step (a) of the method.

In another embodiment the ionic liquid is a salt of a quaternary ammonium cation such as N,N-diethyl-N-methyl-N-(2-methoxyethyl)ammonium (DEME) and its homologues.

Suitably the water content of the ionic liquid is less than 100 ppm, preferably less than 50 ppm.

The ion-permeable membrane which is located in the electrolyte between adjacent anode and cathode electrodes is suitably made from a polymer or like porous material.

The charging circuit is typically one designed to supply DC power to the supercapacitor and will further include a rectifier if the power source is AC mains.

The monitoring circuit performs the function of monitoring one or more parameters characteristic of the performance of the supercapacitor and/or the operative element. In one embodiment, the parameter(s) monitored include the charge status and/or the electrical resistance of the supercapacitor. In another the parameter(s) monitored include a count of the number of charge/discharge cycles which the supercapacitor has undergone. In yet another, the parameter(s) monitored include the location of the device or the wear-characteristics of the operative element. Changes in such parameters may be made manifest as a current, voltage or resistance change or profile characteristic of the status of the operative element and/or the supercapacitor which can be into a corresponding data stream which is passed to a transmitter for onward transmission to a remote location where it is analysed and/or stored in a computer database. Suitably, this transmitter is Wi-Fi-enabled, Bluetooth-enabled, or connected to the remote location by a fixed landline; e.g. a telephone line. It may also be connected by radio or microwave. The periodicity of transmission may be adjusted upon a command from the receiving location.

The device is likewise provided with a receiver, also Wi-Fi-enabled, Bluetooth-enabled, or connected to the remote location by a fixed landline, radio or microwave, which in one embodiment may be integral with the transmitter for receiving instructions from the remote location for implementation by the control unit and/or the operative element or supercapacitor.

In one embodiment, some or all of the electrical components of the device are located in a robust shell, for example an insulated, waterproof or corrosion- or impact-resistant shell. In another embodiment, the shell is rigid and made from a hard-wearing material such as metal or an engineering plastic. Alternatively it is flexible and made from polymer film e.g. polyethylene, polypropylene, polyester or the like. In yet another, the shell is adapted to dock into a corresponding docking location connected to the external power source and adapted to cooperate with the charging circuit. Optionally, the electrical device further includes a lithium-ion battery as the primary or secondary power source for the operative element. If a lithium-ion battery is included, the components are suitably arranged so that the supercapacitor's duty includes or is limited to the trickle charging of the battery.

In another embodiment, there is provided a plurality of units comprising some or all of the components described above linked together and to optionally a common receiving/transmission station at the remote location by means of a network which Wi-Fi or Bluetooth enabled. In this embodiment the network suitably comprises, a lighting system, an alarm system, a detection system for noxious substances or an industrial control system.

1. An electrical device characterised by comprising:
at least one operative element for performing the assigned duty of the device;
a supercapacitor comprised of nano-carbon containing electrodes, an ionic liquid electrolyte and an ion-permeable membrane for powering the operative element and/or recharging an associated battery;
a charging circuit for recharging the supercapacitor by means of an external source of power;
a control circuit for controlling operation of the operative element;
a monitoring circuit for monitoring one or more parameters characteristic of the performance of the supercapacitor and/or the operative element and for generating corresponding status information;
a transmitter for transmitting a first signal comprising the status information to a remote receiving location and
a receiver for receiving a second signal from the remote receiving location comprising instructions to be acted on by the control unit and optionally the operative element.

2. An electrical device as claimed in claim 1 characterised in that the parameter(s) monitored include the charge status of the supercapacitor.

3. An electrical device as claimed in claim 1 characterised in that the parameter(s) monitored include the electrical resistance and/or the capacitance of the supercapacitor.

4. An electrical device as claimed in claim 1 characterised in that the parameter(s) monitored include a count of the number of supercapacitor charge and discharge cycles.

5. An electrical device as claimed in claim 1 characterised in that the parameter(s) monitored include the location of the device.

6. An electrical device as claimed in claim 1 characterised in that it is a power tool and that the parameter(s) monitored include the wear-characteristics of the operative element.

7. An electrical device as claimed in claim 1 characterised in that the transmitter and receiver are connected by telephone line, radio, microwave, Bluetooth or Wi-Fi.

8. An electrical device as claimed in claim 1 characterised in that electrical device further comprises a robust shell for containing the electrical components of the device.

9. An electrical device as claimed in claim 8 characterised in that shell is adapted to dock with a corresponding docking location connected to the external source of power.

10. An electrical device as claimed in claim 1 characterised by further comprising a lithium-ion battery adapted to receive a trickle-charge from the supercapacitor.

11. An electrical device as claimed in claim 1 characterised in that nano-carbon containing carbon electrodes comprise nano-carbon containing components selected from graphene, carbon nanotubes or mixtures thereof embedded in a conducting polymer matrix.

12. An electrical device as claimed in claim 11 characterised in that the nano-carbon containing carbon electrodes include a non-graphitic carbon having a polycrystalline structure and a surface area in the range 1 to 500 m²g⁻¹.

13. An electrical device as claimed in claim 1 characterised in that the ionic liquid comprises one or more of the cations; 1-ethyl-3-methylimidazolium (EMIM), 1-butyl-3-methylimidazolium (BMIM), 1-methyl-1-propylpyrrolidinium, 1-methyl-1-butylpyrrolidinium and one or more of the anions tetrafluoroborate, FSI or TFSI.

14. A network of electrical devices according to claim 1 characterised by being linked to a common receiving/transmitting station at the remote location by Wi-Fi or Bluetooth.

15. A network as claimed in claim 14 characterised by comprising a lighting system, an alarm system, a detection system for noxious substances or an industrial control system.
